(19) United States
(12) Patent Application Publication
(10) Pub. No.: US 2024/0198949 A1
(43) Pub. Date: Jun. 20, 2024

(54) CAR SEAT COVER

(71) Applicant: Ganzhou Lingyue Automotive Products Co., Ltd., Ganzhou (CN)

(72) Inventors: Jinjin Li, Ganzhou (CN); Qinghua Li, Ganzhou (CN)

(21) Appl. No.: 18/430,753

(22) Filed: Feb. 2, 2024

(51) Int. Cl. B60R 21/215; B60N 2/58; B60R 21/207

(52) U.S. Cl. CPC B60R 21/215; B60N 2/5883; B60R 21/207

(57) ABSTRACT

The present disclosure provides a car seat cover, including a seat cushion protective cover, a backrest protective cover, and a headrest protective cover. A storage bag is arranged on a rear side of the backrest protective cover. An opening of the storage bag is provided with a strip-shaped accommodating cavity, and a shaping adhesive strip is arranged in the strip-shaped accommodating cavity. The backrest protective cover is provided with a first inlet-outlet. A backrest inner core enters and exits the backrest protective cover through the first inlet-outlet. A first zipper is arranged on the first inlet-outlet. An air bag window is formed in one side of the backrest protective cover.

### TECHNICAL FIELD

The present disclosure relates to the technical field of seat covers, and in particular, to a car seat cover.

### BACKGROUND

All cars are equipped with car seats for drivers and passengers to sit and lean. Car seat covers are jackets for wrapping and protecting inner cores of the car seats. Existing car seat covers have the following problems: 1, an opening of a storage bag at a back of a backrest lacks a shaping structure, and the opening easily deforms and becomes slack, which affects the attractiveness; 2, an air bag on the side of the car seat is stitched inside the seat cover, there are certain obstacles to the opening of the air bag, a situation that the air bag cannot be normally opened occurs, and there are certain potential safety hazards; and 3, a headrest part and a backrest part mainly wrap inner cores in forms of straps, Velcro tapes, and integrally stitching, it is difficult to fill and remove the inner cores, and strap-type and Velcro tape-type seat covers are relatively slack, and have poor fit, thereby affecting the attractiveness. All problems above of the car seat covers need to be improved.

### SUMMARY

A problem to be solved by the present disclosure is to provide a car seat cover, which avoids the slackness of an opening of a storage bag, ensures that an air bag can be opened normally, facilitates filling and removing of an inner core, and improves the attractiveness.

The above technical problems are solved according to the car seat cover provided by the present disclosure. The car seat cover includes a seat cushion protective cover, a backrest protective cover, and a headrest protective cover. A storage bag is arranged on a rear side of the backrest protective cover. The storage bag is formed by stitching three sides of a square sheet material onto the backrest protective cover. An opening of the storage bag is formed between an unstitched side of the square sheet material and the backrest protective cover. A side, close to the opening, of the square sheet material is stitched to an inner side surface of the square sheet material after being rolled inwards to form a strip-shaped accommodating cavity. A shaping adhesive strip is arranged in the strip-shaped accommodating cavity. The backrest protective cover is provided with a first inlet-outlet. A backrest inner core enters and exits the backrest protective cover through the first inlet-outlet. A first zipper for closing the first inlet-outlet is arranged on the first inlet-outlet. An air bag window is formed in one side of the backrest protective cover. An air bag accommodating bag stitched on the air bag window is arranged inside the backrest protective cover. The headrest protective cover is provided with a second inlet-outlet. A headrest inner core enters and exits the headrest protective cover through the second inlet-outlet. A second zipper for closing the second inlet-outlet is arranged on the second inlet-outlet.

Preferably, the backrest protective cover includes a backrest surface. A breathable shaping layer is stitched onto an inner surface of the backrest surface. Breathable holes are distributed on the backrest surface in a penetrating manner.

Preferably, the breathable shaping layer is made of Polyethylene (PE) fibers.

Preferably, plastic keels are arranged on both sides of each of the seat cushion protective cover and the backrest protective cover.

Preferably, the backrest protective cover, the headrest protective cover, and the square sheet material are all made of leather.

The present disclosure has the beneficial effects that: the present disclosure provides a car seat cover. A side, close to an opening, of a square sheet material is stitched to an inner side surface of the square sheet material after being rolled inwards to form a strip-shaped accommodating cavity, and a shaping adhesive strip is arranged in the strip-shaped accommodating cavity, so that the opening will recover to an original shape after being opened each time, which prevents a storage bag from being slacking and deforming after long-time use, and maintains the attractiveness of the storage bag. A first zipper and a second zipper are respectively arranged on a first inlet-outlet of a backrest protective cover and a second inlet-outlet of a headrest protective cover, which facilitates filling and removing of a backrest inner core and a headrest inner core, the backrest protective cover and the headrest protective cover fit better, the slackness is avoided, and the attractiveness is improved; an air bag window communicated with the air bag accommodating bag is formed in one side of the backrest protective cover, so that an air bag may be placed in the air bag accommodating bag, which facilitates normal opening of the air bag, and effectively guarantees safety in cars. Therefore, the car seat cover is worthy of being promoted and used.

### BRIEF DESCRIPTION OF THE DRAWINGS

FIG. 1 illustrates a schematic structural diagram of an appearance from a right front perspective when a car seat cover is mounted on a car seat.

FIG. 2 illustrates a schematic structural diagram of an appearance from a left rear perspective when a car seat cover is mounted on a car seat.

FIG. 3 illustrates a sectional view when a car seat cover is mounted on a car seat.

Descriptions of reference signs in drawings: seat cushion protective cover 10, backrest protective cover 22, backrest surface 220, breathable shaping layer 221, storage bag 23, square sheet material 230, opening 231, shaping adhesive strip 24, first zipper 25, air bag window 26, air bag accommodating cavity 260, headrest protective cover 31, second zipper 32, and plastic keel 40.

### DETAILED DESCRIPTION OF THE EMBODIMENTS

To make a purpose, technical solutions, and advantages of embodiments of the present disclosure clearer, the technical solutions of the embodiments of the present disclosure will be described clearly and completely hereinafter with reference to the accompanying drawings of the embodiments of the present disclosure. Apparently, the described embodiments are part rather than all embodiments of the present disclosure.

On the basis of the described embodiments of the present disclosure, all other embodiments obtained by those of ordinary skill in the art without creative work fall within the scope of protection of the present disclosure.

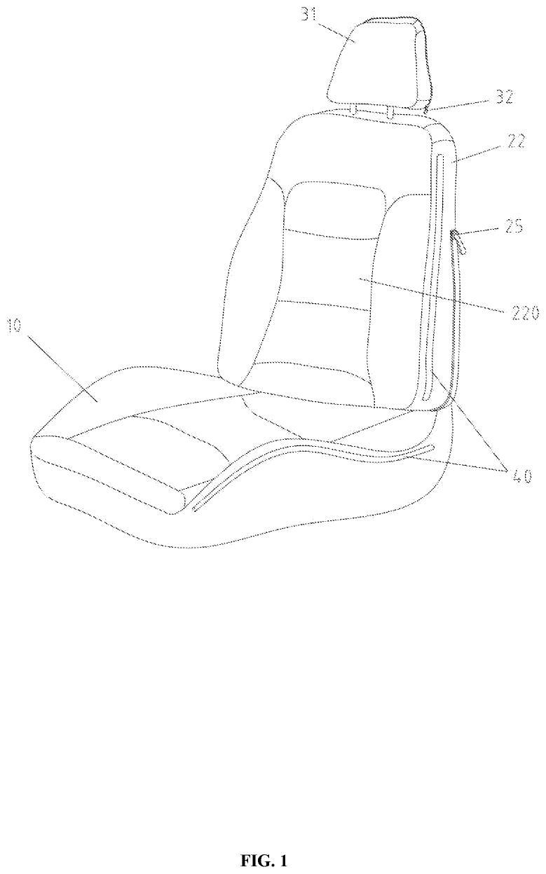

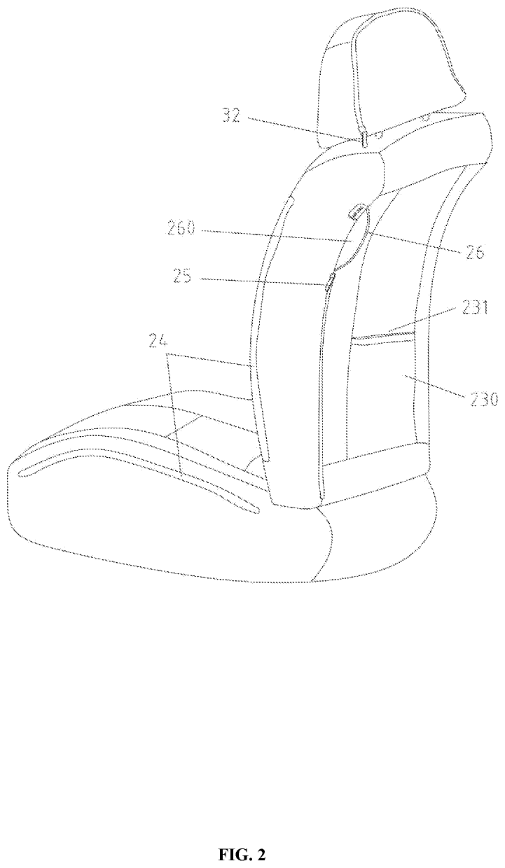

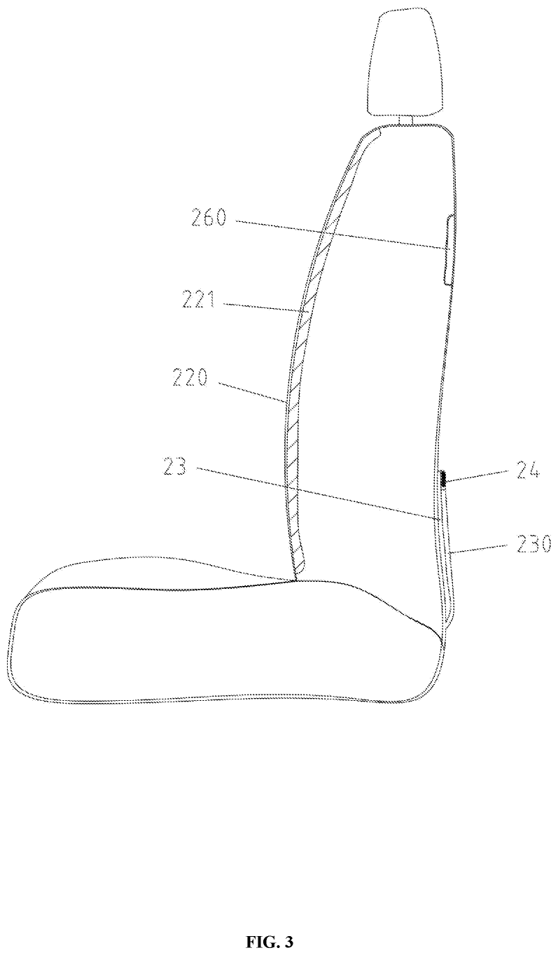

Refer to FIG. 1 to FIG. 3.

The present disclosure provides a car seat cover, including a seat cushion protective cover 10, a backrest protective cover 22, and a headrest protective cover 31. A storage bag 23 is arranged on a rear side of the backrest protective cover 22. The storage bag 23 is formed by stitching three sides of a square sheet material 230 onto the backrest protective cover 22. An opening 231 of the storage bag 23 is formed between an unstitched side of the square sheet material 230 and the backrest protective cover 22. A side, close to the opening 231, of the square sheet material 230 is stitched to an inner side surface of the square sheet material 230 after being rolled inwards to form a strip-shaped accommodating cavity. A shaping adhesive strip 24 is arranged in the strip-shaped accommodating cavity. The backrest protective cover 22 is provided with a first inlet-outlet. A backrest inner core enters and exits the backrest protective cover 22 through the first inlet-outlet. A first zipper 25 for closing the first inlet-outlet is arranged on the first inlet-outlet. An air bag window 26 is formed in one side of the backrest protective cover 22. An air bag accommodating bag 260 stitched on the air bag window 26 is arranged inside the backrest protective cover 22. The headrest protective cover 31 is provided with a second inlet-outlet. A headrest inner core enters and exits the headrest protective cover 31 through the second inlet-outlet. A second zipper 32 for closing the second inlet-outlet is arranged on the second inlet-outlet.

A working principle is that, the side, close to the opening 231, of the square sheet material 230 is stitched to the inner side surface of the square sheet material 230 after being rolled inwards to form the strip-shaped accommodating cavity, and the shaping adhesive strip 24 is arranged in the strip-shaped accommodating cavity, so that the opening 231 will recover to an original shape after being opened each time, which prevents the storage bag 23 from being slacking and deforming after long-time use, and maintains the attractiveness of the storage bag 23. A first zipper 25 and a second zipper 32 are respectively arranged on the first inlet-outlet of the backrest protective cover 22 and the second inlet-outlet of the headrest protective cover 31, which facilitates filling and removing of a backrest inner core and a headrest inner core, the backrest protective cover 22 and the headrest protective cover 31 fit better, the slackness is avoided, and the attractiveness is improved. The air bag window 26 communicated with the air bag accommodating bag 260 is formed in one side of the backrest protective cover 22, so that an air bag may be placed in the air bag accommodating bag 260, which facilitates normal opening of the air bag, and effectively guarantees safety in cars. Therefore, the car seat cover is worthy of being promoted and used.

On the basis of the above embodiments, the backrest protective cover 22 includes a backrest surface 220. A breathable shaping layer 221 is stitched onto an inner surface of the backrest surface 220. Breathable holes are distributed on the backrest surface 220 in a penetrating manner. A shaping effect can be achieved on the backrest surface 220, the air permeability of the backrest surface 220 is improved, passengers are prevented from having stuffy and hot backs, and the riding comfort is higher.

On the basis of the above embodiments, the breathable shaping layer 221 is made of PE fibers, which has a good shaping effect and good air permeability.

On the basis of the above embodiments, plastic keels 40 are arranged on both sides of each of the seat cushion protective cover 10 and the backrest protective cover 22, so that the seat cushion protective cover 10 and the backrest protective cover 22 are more three-dimensional and stylish, a certain effect of shaping is achieved, a seat is prevented from deforming, and the attractiveness is improved.

On the basis of the above embodiments, the backrest protective cover 22, the headrest protective cover 31, and the square sheet material 230 are all made of leather, so that cleaning is facilitated, and the texture and the attractiveness are better.

The above implementations are merely descriptions of preferred embodiments of the present disclosure, and do not limit the scope of the present disclosure. Various modifications and improvements made to the technical solutions of the present disclosure by those of ordinary skill in the art without departing from the design spirit of the present disclosure shall fall within the scope of protection determined by the claims of the present disclosure.

What is claimed is:

1. A car seat cover, comprising a seat cushion protective cover, a backrest protective cover, and a headrest protective cover, wherein a storage bag is arranged on a rear side of the backrest protective cover; the storage bag is formed by stitching three sides of a square sheet material onto the backrest protective cover; an opening of the storage bag is formed between an unstitched side of the square sheet material and the backrest protective cover; a side, close to the opening, of the square sheet material is stitched to an inner side surface of the square sheet material after being rolled inwards to form a strip-shaped accommodating cavity; a shaping adhesive strip is arranged in the strip-shaped accommodating cavity; the backrest protective cover is provided with a first inlet-outlet; a backrest inner core enters and exits the backrest protective cover through the first inlet-outlet; a first zipper for closing the first inlet-outlet is arranged on the first inlet-outlet; an air bag window is formed in one side of the backrest protective cover; an air bag accommodating bag stitched on the air bag window is arranged inside the backrest protective cover; the headrest protective cover is provided with a second inlet-outlet; a headrest inner core enters and exits the headrest protective cover through the second inlet-outlet; and a second zipper for closing the second inlet-outlet is arranged on the second inlet-outlet.

2. The car seat cover according to claim 1, wherein the backrest protective cover comprises a backrest surface; a breathable shaping layer is stitched onto an inner surface of the backrest surface; and breathable holes are distributed on the backrest surface in a penetrating manner.

3. The car seat cover according to claim 2, wherein the breathable shaping layer is made of Polyethylene (PE) fibers.

4. The car seat cover according to claim 2, wherein plastic keels are arranged on both sides of each of the seat cushion protective cover and the backrest protective cover.

5. The car seat cover according to claim 1, wherein the backrest protective cover, the headrest protective cover, and the square sheet material are all made of leather.
